(19) United States
(12) Patent Application Publication
(10) Pub. No.: US 2018/0262597 A1
(43) Pub. Date: Sep. 13, 2018

(54) UNIVERSAL QUALITY OF SERVICE FOR INTERNET OF THINGS DEVICES

(71) Applicant: Citrix Systems, Inc., Fort Lauderdale, FL (US)

(72) Inventors: Chris Matthieu, Phoenix, AZ (US); Jade Meskill, Chandler, AZ (US)

(21) Appl. No.: 15/452,922

(22) Filed: Mar. 8, 2017

(51) Int. Cl. H04L 29/06; H04L 29/08

(52) U.S. Cl. CPC H04L 69/18; H04L 69/26; H04L 67/2871; H04L 67/2819; H04L 67/12

(57) ABSTRACT

A system includes a messaging system server to interface with Internet of Thing (IoT) devices operating with different messaging protocols. The IoT devices include a first IoT device operating with a first messaging protocol and a second IoT device operating with a second messaging protocol that is different from the first messaging protocol. The second IoT device is subscribed to receive messages from the first IoT device. The messaging system server includes a Quality of Service (QoS) database providing at least one guaranteed message delivery option for a message being delivered from the first IoT device to the second IoT device. A device cooperates with the messaging system server to generate commands for controlling the first and second IoT devices, and to associate the at least one guaranteed message delivery option in the QoS database to the message being delivered from the first IoT device to the second IoT device.

### TECHNICAL FIELD

The present disclosure relates to Internet of Things (IoT) devices, and more particularly, to providing Quality of Service (QoS) on message deliveries for IoT devices communicating across different IoT messaging protocols.

### BACKGROUND

Internet of Things (IoT) devices allow objects and even people to be provided with universally unique identifiers (UUIDs), and these IoT devices have the ability to transfer data over a network without requiring human-to-human or human-to-computer interaction. IoT devices have evolved from the convergence of wireless technologies, micro-electromechanical systems (MEMS) and the Internet.

As an example, IoT devices include various information sensing devices, such as sensors, RFID devices, GPS systems, infrared sensors, laser scanners, gas transducers, etc. IoT devices are based on the idea that each device, not just computers and computer networks, can be readable, recognizable, locatable, addressable, and controllable via an IoT platform (e.g., an ad-hoc system or the Internet).

There are many different types of IoT platforms for connecting and controlling IoT devices. Each IoT platform type has a unique messaging protocol. Each IoT messaging protocol has pros and cons based on design concerns related to availability of CPU, memory, network bandwidth, power, radios, etc.

An example IoT messaging protocol is MQ Telemetry Transport (MQTT). One of MQTT's pros is guaranteed delivery of messages which is known as Quality of Service (QoS). MQTT has 3 different QoS levels that determine how each MQTT message is delivered. Another IoT messaging protocol with QoS is Advanced Message Queuing Protocol (AMQP). AMQP defines more than 20 QoS parameters covering reliability, volatility, liveliness, resource utilization, filtering and delivery, ownership, redundancy, timing deadlines, and latency.

QoS for MQTT is limited to IoT devices operating based on the MQTT messaging protocol, and QoS for AMQP is limited to IoT devices operating based on the AMQP messaging protocol. Unfortunately, when a MQTT IoT device or an AMQP IoT device is communicating with an IoT device operating with a different messaging protocol, QoS is not available. Consequently, there is a need for guaranteed message deliveries (i.e., QoS) between IoT devices communicating across different IoT messaging protocols.

### SUMMARY

A system includes a messaging system server configured to interface with a plurality of Internet of Thing (IoT) devices operating with different messaging protocols. The plurality of IoT devices may include a first IoT device operating with a first messaging protocol and a second IoT device operating with a second messaging protocol that is different from the first messaging protocol. The second IoT device may be subscribed to receive messages from the first IoT device. The messaging system server may comprise a Quality of Service (QoS) database providing at least one guaranteed message delivery option for a message being delivered from the first IoT device to the second IoT device. A device may cooperate with the messaging system server to generate commands for controlling the first and second IoT devices, and to associate the at least one guaranteed message delivery option in the QoS database to the message being delivered from the first IoT device to the second IoT device.

The system advantageously allows QoS to be available on message deliveries between IoT devices operating with different messaging protocols. The guaranteed message delivery options are universally applied to the different messaging protocols by the messaging system server even if the messaging protocols were not designed to support QoS. In addition, IoT devices operating with messaging protocols that were designed to support QoS may now have guaranteed message deliveries to IoT devices operating with messaging protocols were not designed to support QoS.

The messaging system server may comprise a QoS message registry, with a copy of the message being stored in the QoS message registry during delivery of the message to the second IoT device.

The at least one guaranteed message delivery option may include an option where the message is to be delivered at least once to the second IoT device to guarantee delivery. The messaging system server may then be configured to perform handshaking between the first and second IoT devices so that the message is delivered at least once to guarantee delivery.

The at least one guaranteed message delivery option may include an option where the message is to be delivered only once to the second IoT device to guarantee delivery. The messaging system server may then be configured to perform handshaking between the first and second IoT devices so that the message is delivered only once to guarantee delivery.

The QoS database may further provide a message delivery acknowledgement option for the message being delivered from the first IoT device to the second IoT device. The device may be further configured to associate the message delivery acknowledgment option to the message being delivered to the second IoT device.

The message delivery acknowledgement option may include delivery of an acknowledgment message or a rejection message. The messaging system server may then be configured to deliver the acknowledgement message to the first IoT device when the message has been delivered to the second IoT device, or deliver the rejection message to the first IoT device when the message has been rejected by the second IoT device.

The messaging system server may comprise a QoS message registry, with a copy of the message being stored by the QoS message registry during delivery of the message to the second IoT device. The QoS database may further provide at least one message retention option for the message being delivered from the first IoT device to the second IoT device. The device may be further configured to associate the at least one message retention option to the message being delivered to the second IoT device.

The at least one message retention option may include a delete option. The messaging system server may then be configured to delete the stored copy of the message in the QoS message registry after delivery of the message to the second IoT device.

The at least one message retention option may include a storage option. The messaging system server may then be configured to keep the stored copy of the message in the QoS message registry after delivery to the second IoT device.

The stored message may include a message body and meta data associated with the message body, with the storage option further including an option for keeping the meta data while deleting the message body. The messaging system server may be further configured to generate a timestamp on when the message was delivered to the second IoT device, with the storage option further including an option for storing the timestamp.

The messaging system server may be further configured to generate at least one restrictions record associated with the plurality of IoT devices, with the at least one restrictions record allowing the messaging system server to control delivery of the message to the second IoT device based on at least one of timing restrictions, location restrictions, presence restrictions and path restrictions.

The messaging system server may be further configured to generate at least one permissions record associated with the plurality of IoT devices, with the at least one permissions record allowing the messaging system server to detect an unauthorized message delivery to the second IoT device.

Another aspect of the disclosure is directed to a method for operating a system as described above. The method comprises operating the messaging system server to interface with a plurality of Internet of Thing (IoT) devices operating with different messaging protocols. The plurality of IoT devices may comprise a first IoT device operating with a first messaging protocol and a second IoT device operating with a second messaging protocol that is different from the first messaging protocol, and with the second IoT device being subscribed to receive messages from the first IoT device. The messaging system server may be operated to include a Quality of Service (QoS) database providing at least one guaranteed message delivery option for a message being delivered from the first IoT device to the second IoT device. The device ay be operated to generate commands for controlling the first and second IoT devices, and to associate the at least one guaranteed message delivery option in the QoS database to the message being delivered from the first IoT device to the second IoT device.

Yet another aspect of the disclosure is directed to a non-transitory computer readable medium having a plurality of computer executable instructions for causing the system as described above to operate.

### BRIEF DESCRIPTION OF THE DRAWINGS

FIG. 1 is a block diagram of a system that supports a cross-protocol, machine-to-machine messaging platform.

FIG. 2 is a block diagram of a computer system representing one or more of the components of the system illustrated in FIG. 1.

FIG. 3 is a block diagram of a system providing QoS to messages delivered by IoT devices operating with different IoT messaging protocols.

FIG. 4 is a flowchart illustrating a method for operating the system illustrated in FIG. 3.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

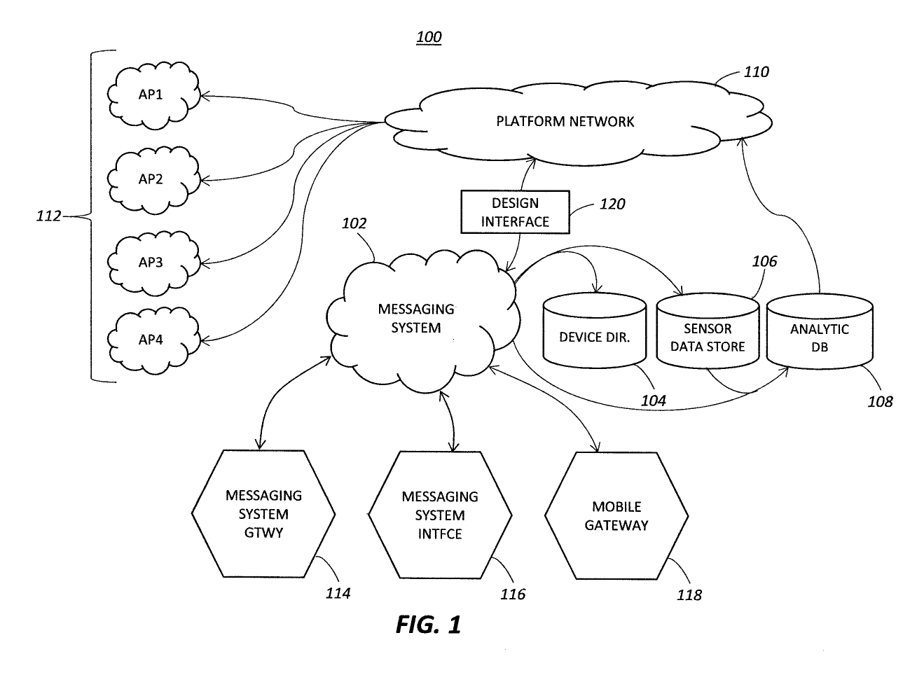

Referring initially to FIG. 1, a system 100 that is a cross-protocol, machine-to-machine messaging platform will be discussed. More particularly, the system 100 allows Internet of Things (IoT) devices to communicate across different IoT messaging protocols. Support for the illustrated system 100 may also be found in U.S. Pat. No. 9,009,230. The '230 patent is assigned to the current assignee of the present application, and is incorporated herein by reference in its entirety.

An IoT device may include any network-connectable device or system having sensing or control functionality. An IoT device may be connectable to a local area network (LAN), a personal area network (PAN), and to a wide area network (WAN). For example, an IoT device may include one or more radios operating using one or more communications protocols that allow the IoT device to connect to one or more LANs or PANs, such as WiFi™, ZigBee™, Bluetooth™, Bluetooth low Energy™ (BLE), Infrared Data Association, Transmission Control Protocol (TCP), User Datagram Protocol (UDP), and any other suitable protocol that allows connection to a LAN.

A LAN may interconnect various network devices and provide the network devices with the ability to connect to a WAN. A router, modem, access point, or other switching mechanism may be used to control and manage the connections to the network devices. A PAN may provide network access for a user's personal devices (e.g., a network for connecting devices worn or carried by the user, for connecting devices located in the user's workspace, or the like), and may further provide access to other networks, such as a LAN or a WAN.

The IoT device may further include one or more radios that allow the IoT device to connect to a WAN, such as the Internet, a private cloud network, a public cloud network, or any other network external to a local network. In some embodiments, an IoT device may not include a cellular radio, and may only be connectable to a LAN, PAN, or WAN other than a cellular network. In some embodiments, in IoT device may include a cellular radio. The system 100 may also include third-party messaging services (e.g., Facebook, twitter, LinkedIn, SMS, etc.) as well as non-IoT devices and systems.

The system 100 may include one or more remote servers, or clouds, that are in communication with other devices or systems via a network, such as the Internet, an intranet, a LAN, a PAN, or a WAN. For example, the system 100 includes a common messaging system 102 (or messaging system 102) that supports machine-to-machine instant message exchange in real-time or near real-time. In some embodiments, the messaging system 102 may be an open source machine-to-machine messaging platform, enabling IoT devices, other devices or machines, and/or systems to exchange messages or otherwise communicate with any other IoT devices, other devices or machines, and/or systems.

The messaging system 102 may be implemented by one or more remote servers and may allow an IoT device, other device or machine, and/or a system to exchange communications or messages with another device or system regardless of whether the devices or systems are built by different manufacturers, operate using different connection protocols or interfaces, or whether the devices or systems are built with the ability to communicate with a network. While only a single messaging system 102 is shown in FIG. 1, one of ordinary skill in the art will appreciate that multiple private or public messaging systems may be implemented using the techniques described herein.

One or more remote servers of the messaging system 102 may be connected to a network via the Internet and/or other connection platforms (e.g., a WAN and/or a LAN) such that the servers may be accessed from anywhere in the world. The remote servers allow IoT devices, other devices or machines, and/or systems connected to the servers via the network to communicate and exchange messages with other IoT devices, other devices or machines, and/or systems from anywhere in the world. The remote servers may be configured with enough processing power to run an application, store and process data, and/or perform any other computing task, in some examples, the remote servers may provide enough processing power to operate applications running on devices located remotely from the servers and applications running on the servers themselves.

Messaging system 102 may be configured to support multiple connection protocols, such as any suitable machine-to-machine connection protocol. For example, the messaging system 102 may support connection protocols such as hypertext transfer protocol (HTTP), websockets, message queuing telemetry transport (MQTT), constrained application protocol (CoAP), Extensible Messaging and Presence Protocol (XMPP), Simple Network Management Protocol (SNMP), AllJoyn, and/or any other suitable connection protocol. The multiple connection protocols supported by the messaging system 102 may be referred to herein as native connection protocols of the messaging system 102.

Messaging system 102 may also support multiple developer platforms, such as one or more software developer kits (SDKs). For example, the messaging system may support SDKs such as Node.JS, JavaScript, Python, Ruby, or any other suitable SDK. The support of multiple developer platforms and protocols provides programmers with the flexibility to customize functions, instructions, and commands for IoT devices, other devices or machines, and/or systems connected to messaging system 102.

The messaging system 102 may include a cloud infrastructure system that provides cloud services. In certain embodiments, services provided by the cloud infrastructure of messaging system 102 may include a host of services that are made available to users of the cloud infrastructure system on demand, such as registration, access control, and message routing for users, devices or machines, systems, or components thereof. Services provided by the messaging system 102 can be dynamically scaled to meet the demands of users.

The messaging system 102 may comprise one or more computers, servers, and/or systems. In some embodiments, the computers, servers, and/or systems that make up the cloud network of the messaging system 102 are different from a user's own on-premises computers, servers, and/or systems. For example, the cloud network may host an application, and a user may, via a communication network such as a WAN, LAN, and/or PAN, on demand, order and use the application.

In some embodiments, the cloud network of the messaging system 102 may host a Network Address Translation Traversal application to establish a secure connection between the messaging system 102 and a device or machine. A separate secure connection (e.g., using a native protocol of the messaging system 102) may be established by each device or machine for communicating with the messaging system 102. In certain embodiments, the cloud network of the messaging system 102 may include a suite of applications, middleware, or firmware that can be accessed by a user, device or machine, system, or component thereof.

Upon registering with the messaging system 102, each device or machine, person, and/or system may be assigned a unique identifier and a security token. For example, a device (IoT or other device) or system connected to the messaging system, a person associated with an account or an application that utilizes the messaging system, or the like may be assigned or otherwise provided with a distinct universally unique identifier (UUID) and/or a distinct security token.

Each IoT device, other device or machine, system, and/or person using a device must communicate its distinct UUID and security token to the messaging system 102 in order to access the messaging system 102. The messaging system 102 may authenticate the device, other device or machine, system, and/or person using each respective distinct UUID and token. The messaging system 102 may use the UUIDs to process, route, and/or otherwise manage messages and other communications to an appropriate device, person, system, and/or machine. For example, a device may send a message with its UUID and a destination UUID for the device, system, or person to which the message is destined. The messaging system 102 may process, route, and/or otherwise manage the message so that it is received at the appropriate destination.

In some embodiments, one or more components or programs of a device or system may also be assigned a unique identifier and a security token. In some cases, the unique identifier and/or token for the components of a device or system may be the same as the unique identifier and/or token of the device or system itself. In some cases, the unique identifier and/or token for a component or program of a device or system may be different from that of the device or system and may be unique only to the component or program.

In some embodiments, components of a device or system that may be assigned a unique identifier may include a sensor (e.g., a camera, motion sensor, temperature sensor, accelerometer, gyroscope, or any other available sensor), an output (e.g., a microphone, siren, display, light, tactile output, or any other available output), a third-party messaging service that the device or system is able to run, or any other component of a device or system that can be identified, accessed, and/or controlled.

Messaging system 102 may further be configured to interact with any application programming interface (API). Each API may also be assigned or otherwise provided with a unique identifier (e.g., a distinct UUID) and/or a security token. Assigning APIs with a unique identifier enables messaging system 102 to receive instructions from and provide instructions to any IoT device, other device or machine, and/or system that is connected to the messaging system 102. By being able to interact with any API, messaging system 102 may control the functionality of all components of a registered IoT device, other device or machine, and/or system that are accessible by the messaging system 102. In some embodiments, messaging system 102 may be configured such that a single message transmitted by messaging system 102 may be communicated to multiple devices and/or systems having different APIs.

Accessible IoT devices, other devices or machines, and/or systems include any device that has been registered with messaging system 102 and that has been assigned a unique identifier and/or a security token. For example, a user may purchase an IoT device. The user must register the IoT device with the messaging system 102, and may be assigned a UUID and security token by the messaging system 102 to make the IoT device accessible to the messaging system 102 and other devices registered with the messaging system 102.

Using the common messaging system 102, people, devices, systems, and/or components thereof that have assigned UUIDs can query and communicate with a network of other people, devices, system, and components thereof that have assigned UUIDs and that meet specific search criteria. For example, a device may query the common messaging system 102 searching for a specific type of device or devices that are located in a particular area, and may receive a list of UUIDs for devices that meet the search criteria. The device may then send a message with a destination UUID assigned to the destination device to which the device wants to send a message.

In some embodiments, messaging system 102 may also detect, connect, and/or communicate with other servers, allowing messaging system 102 to route messages to IoT devices, other devices or machines, and/or systems on the other servers via a server-to-server connection. Server-to-server communications may include connections used to transfer data from one server to another server. For example, a user may use multiple cloud servers to store different types of information. A user may want to transfer data from a first server of a first cloud network to a second server of a second cloud network. A server-to-server communication allows the user to directly transfer or otherwise share this information with the second server.

As another example, the messaging system 102 supports inter-cloud communications to allow people, devices or machines, systems, or components thereof to route messages across clouds to other people, devices or machines, systems, or components thereof registered with other clouds. For instance, a device connected to a private or public cloud network may send a message to another device connected to another private or public cloud.

IoT devices, other devices or machines, and/or systems may be able to connect with the messaging system 102 in several ways. In some embodiments, devices and systems may communicate with the messaging system 102 using a messaging system gateway or hub. For example, IoT devices, other devices or machines, and/or systems may communicate with the messaging system 102 using messaging system gateway 114. The messaging system gateway 114 may be connected to a same LAN as the devices that use the messaging system gateway 114. For example, the messaging system gateway 114 may be installed at a location, such as a home, office, a sports venue, an outside environment (e.g., a park, a city, or the like), or any other suitable location.

In some embodiments, the messaging system gateway 114 includes an instance of messaging system software that is configured to interact with the messaging system 102. In some cases, the messaging system gateway 114 may be run on an operating system, such as, but not limited to, Linux™, Mac® OS, and/or Windows™.

In some embodiments, a messaging system gateway 114 may be a standalone physical device, such as a wireless router or modem, which runs the gateway software that connects to the messaging system 102 using a WAN. In some embodiments, a messaging system gateway 114 may be integrated into an IoT device, other device or machine, and/or system by installing the gateway software onto the IoT device, other device or machine, and/or system. For example, the messaging system gateway 114 may be run on computing devices such as a Raspberry Pi, a home and/or office computer, Intel™ Galileo, Beagle Bones, Yuns, and/or other suitable computing device.

Regardless of physical form, the messaging system gateway 114 may operate as an intermediary between the messaging system 102 and the devices or systems that use the messaging system gateway 114. For example, IoT devices, other devices or machines, and/or systems may be connected to messaging system gateway 114, which then links the IoT devices, other devices or machines, and/or systems to the messaging system 102 in real-time.

The connection of a device or system to the messaging system 102 via the messaging system gateway 114 allows connected IoT devices, other devices or machines, and/or systems to communicate with one another in real-time. IoT devices, other devices or machines, and/or systems may be connected to messaging system gateway 114 using one or more native connection protocols of the IoT device, other device or machine, and/or system.

The protocols may include, but are not limited to, Transmission Control Protocol (TCP), User Datagram Protocol (UDP), WiFi, ZigBee, Bluetooth low energy (BLE), HTTP, websockets, MQTT, CoAP, XMPP, SNMP, AllJoyn, and/or any other suitable connection protocol. In some embodiments, messaging system gateway 114 may broadcast a private network signal such that registered devices and systems may securely connect to the messaging system gateway 114 and to the messaging system 102. Devices and systems that do not have access to the messaging system gateway 114 and messaging system 102 may be unable to process the private network signal.

In some embodiments, messaging system gateway 114 is on a LAN side of a firewall, such as a network address translations (NAT) firewall implemented using a router, or other suitable firewall. In some cases, the messaging system gateway 114 may use websockets to connect to the messaging system 102. The connection between websockets of the messaging system gateway 114 and the messaging system 102 may include a bi-directional persistent connection. The bi-directional persistent connection may auto-reconnect as WAN (e.g., Internet, or the like) connectivity becomes available.

By locating the messaging system gateway 114 inside of the firewall, only communications to and from the messaging system gateway 114 have to be granted access to the firewall. Accordingly, the messaging system 102 and any system and/or device connected to the messaging system gateway 114 may communicate through the firewall via the messaging system gateway 114. The messaging system gateway 114 may be used by a person or business to connect various IoT devices, other devices or machines, and/or systems to the messaging system 102, serving as a secure connection for communicating with messaging system 102, much like a personal firewall.

Devices and systems may also be able to communicate with the messaging system 102 using a mobile messaging system gateway that is installed on a mobile device. For example, IoT devices, other devices or machines, and/or systems may be able to connect with the messaging system 102 using a mobile gateway 118. The mobile gateway 118 may be similar to a messaging system gateway 114, but instead is installed and operated on a mobile device. For example, mobile gateway 118 may be installed on a mobile phone, tablet, laptop, wearable device, or other suitable mobile device.

The mobile gateway 118 may allow the mobile phone to connect to the messaging system 102. The mobile gateway 118 may access all sensors on the mobile device. For example, geolocation sensor data, compass headings, accelerometer data, or any other sensor data of a mobile phone may be provided to the messaging system 102 through mobile gateway 118. In some embodiments, the mobile gateway 118 may be installed in wearable technology, such as pedometers, headsets, watches, and the like, as well as in Bluetooth™ low-energy devices.

In some embodiments, the mobile gateway 118 may also provide a personal area network (PAN) and may allow other devices that are connectable to the mobile device to connect to the messaging system 102 via the mobile gateway 118. For example, one or more devices that do not have an Internet Protocol address and that are not able to connect to a LAN (e.g., a WiFi network or the like) may connect to the mobile gateway 118 using a wired interface or a short-range communication protocol interface, such as Bluetooth, BLE, Zigbee, near field communication (NFC), radio frequency (RF), infrared (IR), or any other suitable communication protocol.

These devices may then connect to messaging system 102 through the mobile gateway 118 of the mobile device. The mobile gateway 118 may operate to exchange communications between the devices and the messaging system 102. Devices that do not have an Internet Protocol address and that are not able to connect to a local area network may include wearable technology or other similar devices that only have access to a PAN.

In some embodiments, an IoT device, other device or machine, and/or system may connect with messaging system 102, the messaging system gateway 114, and/or the mobile gateway 118 using a universal messaging system interface 116 that is programmed into the device or system. The built-in universal messaging system interface 116 (or universal interface 116) allows a device or system to perform operations that native firmware of the device or system does not allow it to perform. For example, the messaging system interface 116 may override the native firmware of a device to allow the device to perform various operations that are outside of the functionality of the native firmware.

In some embodiments, the messaging system interface 116 may be installed on a device that does not have the ability to communicate with other devices using one or more connection protocols. In such embodiments, the messaging system interface 116 may provide the device with the capability to use one or more connection protocols. The messaging system interface 116 may access one or more sensors, inputs, outputs, or programs on the device or system in order to perform various operations. For example, the messaging system interface 116 may have access to and control a geolocation sensor, a compass, a camera, a motion sensor, a temperature sensor, an accelerometer, a gyroscope, a graphical interface input, a keypad input, a touchscreen input, a microphone, a siren, a display, a light, a tactile output, a third-party messaging service that the device or system is able to run, or any other component of a device or system that can be identified, accessed, and/or controlled.

In some embodiments, the built-in universal messaging system interface 116 may include an operating system that allows the device to communicate with the messaging system 102. Messaging system interface 116 may be installed on an IoT device, other device or machine, and/or system server. For example, the messaging system interface 16 may be installed on a Raspberry Pi board, an Arduino board, a microcontroller, a minicomputer, or any other suitable computing device.

In some embodiments, a device or system running the messaging system interface 116 may connect directly to messaging system 102. In some embodiments, a device or system running the messaging system interface 116 may connect to the messaging system 102 via the messaging system gateway 114 or the mobile gateway 118. The messaging system interface 116 run by the device or system may be assigned a UUID and a token. The messaging system interface 116 may connect to the messaging system 102 using the assigned UUID and token, and may await further instructions from the messaging system 102.

In some embodiments, the messaging system 102 may act as a compute server that controls the messaging system interface 116. For example, messaging system 102 may activate and/or deactivate pins of the computing device running the messaging system interface 116, request sensor data from the computing device, and/or cause the messaging system interface 116 to perform other functions related to the computing device. In some embodiments, the messaging system interface 116 can be connected to a gateway (e.g., messaging system gateway 114 or mobile gateway 118), and the gateway may act as a compute server that controls the messaging system interface 116 in a similar manner as described above. In some embodiments, messaging system interface 116 may be a mobile operating system or application that is able to run on mobile device operating systems, such as iOS and Android™ operating systems.

Information obtained by messaging system 102, including information transmitted to messaging system 102 by messaging system gateway 114, mobile gateway 118, messaging system interface 116 and/or directly from an IoT device or system, may be transmitted to one or more data storage systems. For example, information about IoT devices, other devices or machines, and/or systems registered with the messaging system 102 may be transmitted to device directory 104 for storage.

In some embodiments, the information about the IoT device, other device or machine, and/or system may be stored in device directory 104 upon registration of the IoT device, other device or machine, and/or system. For example, information stored in device directory 104 for a device or system may include a unique identifier (e.g., a UUID), a token, information related to when the device or system comes online or offline, a permissions record (described below), a security profile (described below), and/or any other relevant information.

In some embodiments, the device directory 104 is queriable, such that a device, system, or user may be provided with a list and/or array of IoT devices, other devices or machines, and/or systems that fit requested search criteria. The messaging system 102 may access the device directory 104 upon receiving a query from a device, system, or user. Upon polling the device directory 104 according to the criteria specified in a query made by a device, the messaging system 102 may provide the device with a list or array of unique identifiers (e.g., UUIDs) assigned to IoT devices, other devices or machines, and/or systems that are currently online and that the device has access to according to the device's UUID and/or security token.

As described in further detail below, the device's access may be determined using permission records and/or security profiles of the IoT devices, other devices or machines, and/or systems that meet the search criteria of the query. For example, a permissions record operates as a security feature, ensuring that devices, systems, and users only have access to other devices, systems, and users to which permission has been granted.

In some embodiments, sensor data from sensors of registered IoT devices, other devices or machines, and/or systems may be transmitted to sensor data storage 106. The sensor data may be streamed from a registered IoT device, other device or machine, and/or system through messaging system 102 in real-time. Sensor data storage 106 is queriable such that a user, device, or system may poll sensor data storage 106 to receive data from specified sensors during a specified time period.

A user, device, or system may also be able to query the sensor data storage 106 for all available data from one or more sensors. In some embodiments, information from sensor data storage 106, as well as additional information from messaging system 102, may be transmitted to an analytics database 108. In some embodiments, analytics database 108 may not be queried by a user of the system 100. In other embodiments, analytics database 106 may be queried by a user of the system 100. The information stored in analytics database 108 may be accessible via a platform network 110.

In some embodiments, multiple servers or other systems may each operate an instance of software that includes the messaging system 102, thus creating multiple cloud servers and/or instances of messaging systems 102. In some embodiments, a particular instance of messaging system 102 may have its own UUID that allows the instance of messaging system 102 to connect to another instance of messaging system 102 to form a mesh network of messaging systems. Other networks and devices or machines may also be part of the mesh network, such as LANs and PANs and the devices or machines that are interconnected using the LANs and PANs.

Each of the LANs and PANs can have their own unique UUID and/or token registered with the messaging system 102. The LANs and PANs are addressable using their unique UUID, and can also address other UUIDs around the world. Such a mesh network may allow messages and other communications to be routed between devices across messaging systems 102. Accordingly, the messaging system 102 supports inter-cloud communications to allow people, devices or machines, systems, or components thereof to route messages across clouds to other people, devices or machines, systems, or components thereof on other clouds. Each of the cloud networks may run an instance of the messaging system 102. For instance, a device connected to a private or public cloud network may send a message to another device connected to another private or public cloud.

As described above, each person, device or machine, system (e.g., cloud network running an instance of the messaging system, a LAN, a PAN, or the like), or components thereof, that is registered with the messaging system 102 is assigned a UUID. Each person, device or machine, system, or components thereof can be referenced by the messaging system using its UUID. Each of the UUIDs can discover other UUIDs (e.g., clouds, other networks, people, or devices or machines) using one or more queries, such as using multicast Domain Name System (MDNS) or API queries.

In some embodiments, a UUID can connect to multiple networks thus forming a global mesh network including different networks (e.g., multiple cloud networks, LANs, PANs, or a combination of cloud networks, LANs, and/or PANs). A cloud network running an instance of messaging system may also be assigned a UUID and can route messages across cloud networks via inter-cloud communications using a routing paradigm. For example, a cloud network can send a message across cloud networks by sending the message with a route UUID_1/UUID_2/UUID_3/UUID_4, with each UUID being assigned to a different cloud network. In some embodiments, the mesh network may route the message based on known connections.

Platform network 110 may include one or more analytics engines that may process the information received from the analytics database 108. The analytics engines may aggregate the received information, detect trends, and/or perform other analytics on the information. Platform network 110 may be communicatively coupled with a number of APIs 112 that are used to create, manage, identify, and/or communicate with functions of different IoT devices, other devices or machines, and/or systems.

APIs may include, for example, sales analytics APIs, social media account and other third-party messaging account APIs, stock quote APIs, weather service APIs, other data APIs, mobile application APIs, and any other suitable API. For example, a Facebook™ or other social media message may use a messaging API to send SMS messages. Platform network 110 may use the messaging API to deliver a message to a device or system configured to display a SMS message.

A light API may be provided by a manufacturer of “smart” light bulbs. The platform network 110 may utilize the light API to provide an output to turn a light bulb connected to the platform network 110 on or off. Platform network 110 is also in communication with messaging system 102 using the APIs of messaging system 102. Platform network 110 may interact with the IoT devices, other devices or machines, and/or systems connected through the messaging system 102 using UUIDs and/or security tokens.

The UUIDs and/or security tokens may be issued by the messaging system 102 and/or the platform network 110. In some embodiments, a user may register systems and/or devices with the messaging system 102. The platform network 110 may import or otherwise utilize any UUIDs and/or tokens issued by the messaging system 102 during the registration. In some embodiments, a user may register devices and/or systems with the platform network 110.

The platform network 110 may issue UUIDs and security tokens to IoT devices, other devices or machines, and/or systems upon registration of the IoT device, other device or machine, and/or system. The UUIDs and security tokens are used to access the messaging system 102, as described above. In some embodiments, a user may register devices and/or systems with both the messaging system 102 and the platform network 110. Either messaging system 102 or platform network 110 may issue UUIDs and/or tokens. Registration with the non-issuing system or network creates a link or other association with the issued UUIDs and/or security tokens.

Platform network 110 may operate an application or other program that provides a designer graphical interface that allows a user to create a control system or flow. The designer graphical interface may allow the user to create a control system by dragging and dropping blocks that represent various devices and/or systems of the control system, blocks that represent inputs and/or outputs from the various devices and/or systems, and/or blocks that represent functions for controlling the devices and/or systems.

Any IoT device, other device or machine, and/or system that is registered with platform network 110 may be configured to receive or transmit a message to any other IoT device, other device or machine, and/or system that is registered with platform network 110 using an appropriate control system designed using the designer graphical interface. Messages may be transmitted from one device or system to control operation of another device or system. For example, the platform network 110 may run control systems continuously, such that an input from a device or system may automatically cause an event to occur in a different location and/or by a different device or system.

Such functionality, along with access to the data from analytics database 108, enables the platform network 110 to monitor a performance, behavior, and/or state of any IoT device, other device or machine, and/or system within the control system, and to send a resulting message or communication to any other IoT device, other device or machine, and/or system in the control system based on the monitored performance, behavior, and/or state. In another example, the platform network 110 may run a control system designed using the designer graphical interface upon receiving a command, such as from a user or from another device or system.

In some embodiments, the designer graphical interface operated by the platform network 110 may access any IoT device, other device or machine, and/or system connected to messaging system 102, including IoT devices, other devices or machines, and/or systems connected using the messaging system gateway 114, messaging system interface 116, and/or mobile gateway 118. This connection enables control systems created using the designer graphical interface to control output functions of devices and/or systems registered with the messaging system 102. For example, real-time monitoring of data at a remote location, such as performance of a machine or system, or of a person's health condition may be performed by the platform network 110.

The platform network 110 may also automatically provide messages or other outputs, including commands, to any of the registered IoT devices, other devices or machines, and/or systems based on processes performed on information received from IoT devices, other device or machine, and/or system. For example, sensor data may be received from an IoT device and processed by analytics systems of the platform network 110. Using artificial intelligence and/or machine learning within the platform network 110, the processed sensor data may be used to provide commands to another system or device connected to platform network 110.

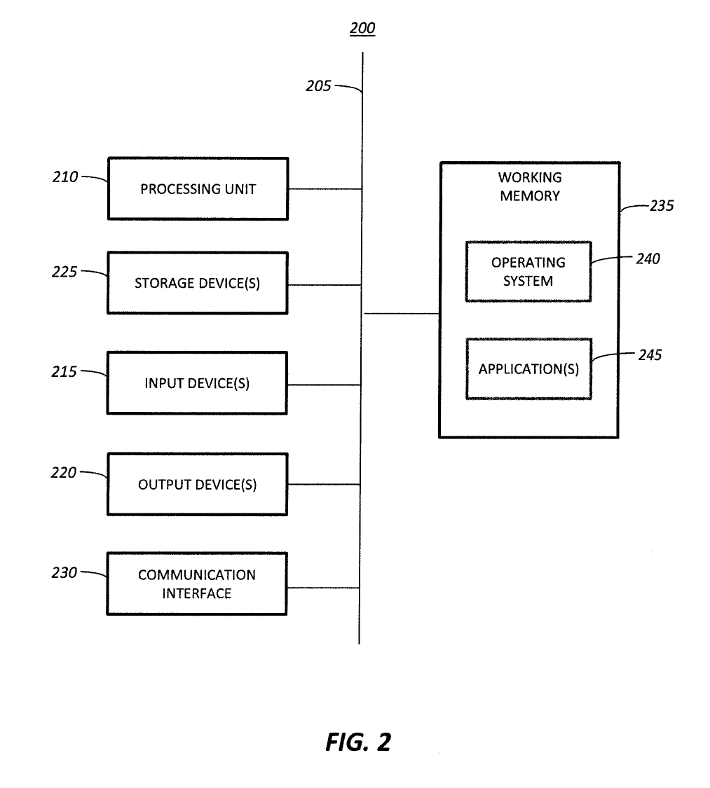

Referring now to FIG. 2, a computer system representing one or more of the components of the messaging system 102, the platform network 108, the messaging system gateway 114, the messaging system interface 116, or the mobile gateway 118 will be discussed.

FIG. 2 provides a schematic illustration of one embodiment of a computer system 200 that can perform the methods provided by various other embodiments, as described herein, and/or can function as the host computer system, a remote kiosk/terminal, a point-of-sale device, a mobile device, and/or a computer system. FIG. 2 is meant only to provide a generalized illustration of various components, any or all of which may be utilized as appropriate. FIG. 2, therefore, broadly illustrates how individual system elements may be implemented in a relatively separated or relatively more integrated manner.

The computer system 200 is shown comprising hardware elements that can be electrically coupled via a bus 205 (or may otherwise be in communication, as appropriate). The hardware elements may include a processing unit 210, including without limitation one or more general-purpose processors and/or one or more special-purpose processors (such as digital signal processing chips, graphics acceleration processors, or other appropriate data processor); one or more input devices 215, which can include without limitation a mouse, a keyboard, a touchscreen, a global positioning system (GPS) receiver, a motion sensor, a camera, and/or the like; and one or more output devices 220, which can include without limitation a display device, a speaker, a printer, and/or the like.

The computer system 200 may further include (and/or be in communication with) one or more non-transitory computer-readable storage mediums or devices 225, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 200 might also include a communication interface 230, which can include without limitation a modem, a network card (wireless or wired), an infrared communication device, a wireless communication device and/or chipset (such as a Bluetooth™ device, an 802.11 device, a WiFi device, a WiMax device, an NFC device, cellular communication facilities, etc.), and/or similar communication interfaces. The communication interface 230 may permit data to be exchanged with a network (such as the network described below, to name one example), other computer systems, and/or any other devices described herein.

In many embodiments, the computer system 200 will further comprise a non-transitory working memory 235, which can include a RAM or ROM device, as described above. The computer system 200 may further include one or more receivers and one or more transmitters. For example, the communication interface 230 may include one or more receivers and one or more transmitters. In another example, the computer system 200 may include one or more transceivers, one or more receivers, and/or one or more transmitters that are separate from the communication interface 230.

The computer system 200 also can comprise software elements, shown as being currently located within the working memory 235, including an operating system 240, device drivers, executable libraries, and/or other code, such as one or more application programs 245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the one or more non-transitory computer-readable storage mediums or devices 225 described above. In some cases, the storage medium might be incorporated within a computer system, such as computer system 200. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 200 and/or might take the form of source and/or installable code, which, upon compilation and/or installation on the computer system 200 (e.g., using any of a variety of generally available compilers, installation programs, compression/decompression utilities, etc.) then takes the form of executable code.

In some examples, a receiver of the computer system 200 may receive a communication from a first Internet of Things (IoT) device, wherein the communication is destined for a second IoT device, wherein the first IoT device is assigned a first universally unique identifier, and wherein the communication includes a second universally unique identifier assigned to the second IoT device. In such examples, the one or more non-transitory computer-readable storage mediums or devices 225 may contain instructions which when executed on the one or more data processors, cause the one or more processors to perform operations including obtaining the second universally unique identifier, determining that the second universally unique identifier is assigned to the second IoT device, and determining, using the second universally unique identifier, that the communication received from the first IoT device is an unauthorized message attempt by the first IoT device to exchange a message with the second IoT device.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system.

For example, a journey planning and pricing engine configured to provide some or all of the features described herein relating to the journey planning and/or pricing can comprise hardware and/or software that is specialized (e.g., an application-specific integrated circuit (ASIC), a software method, etc.) or generic (e.g., processing unit 210, applications 245, etc.) Further, connection to other computing devices such as network input/output devices may be employed.

Some embodiments may employ a computer system (such as the computer system 200) to perform methods in accordance with the disclosure. For example, some or all of the procedures of the described methods may be performed by the computer system 200 in response to processing unit 210 executing one or more sequences of one or more instructions (which might be incorporated into the operating system 240 and/or other code, such as an application program 245) contained in the working memory 235. Such instructions may be read into the working memory 235 from another computer-readable medium, such as one or more of the storage device(s) 225. Merely by way of example, execution of the sequences of instructions contained in the working memory 235 might cause the processing unit 210 to perform one or more procedures of the methods described herein.

In an embodiment implemented using the computer system 200, various computer-readable storage media might be involved in providing instructions/code to processing unit 210 for execution and/or might be used to store and/or carry such instructions/code (e.g., as signals). In many implementations, a computer-readable storage medium is a physical and/or tangible storage medium. Such a medium may take many forms, including but not limited to, non-volatile media, volatile media, and transmission media.

Non-volatile media include, for example, optical and/or magnetic disks, such as the storage device(s) 225. Volatile media include, without limitation, dynamic memory, such as the working memory 235. Transmission media include, without limitation, coaxial cables, copper wire and fiber optics, including the wires that comprise the bus 205, as well as the various components of the communication interface 230 (and/or the media by which the communication interface 230 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 230 (and/or components thereof) generally will receive the signals, and the bus 205 then might carry the signals (and/or the data, instructions, etc. carried by the signals) to the working memory 235, from which the processor(s) 205 retrieves and executes the instructions. The instructions received by the working memory 235 may optionally be stored on a non-transitory storage device 225 either before or after execution by the processing unit 210.

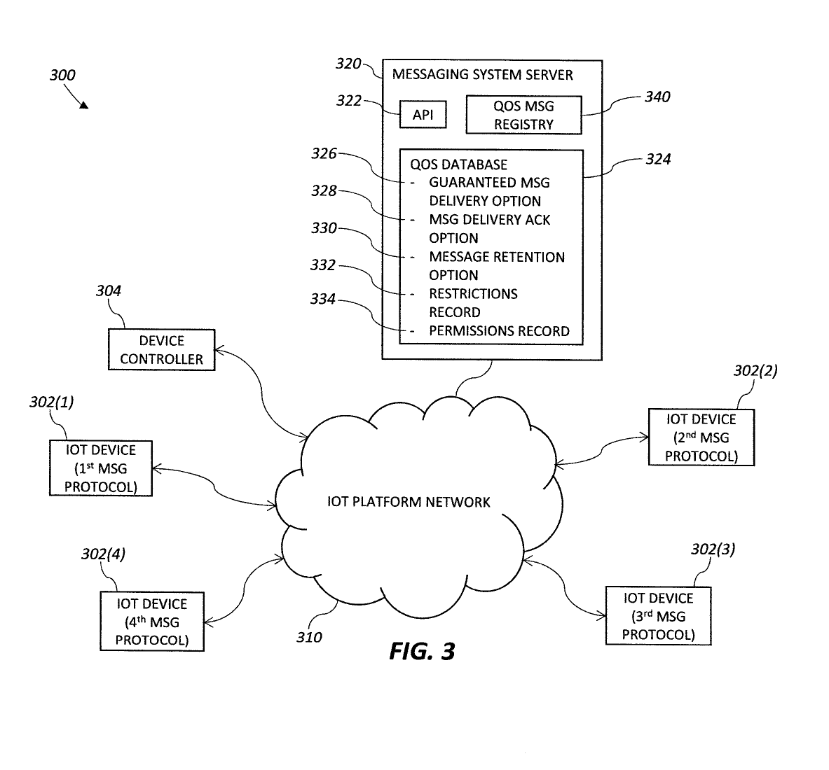

Referring now to FIG. 3, another aspect of the disclosure is directed to a system 300 providing a universal Quality of Service (QoS) for message delivery between IoT devices 302 operating with different IoT messaging protocols. QoS is universal in the sense that QoS is now available to IoT devices 302 regardless of the IoT messaging protocols being used. This includes IoT messaging protocols that were not designed to support QoS, and IoT messaging protocols that were designed to support QoS.

The IoT devices are generally indicated by reference 302 while specific IoT devices in the illustrated embodiment are addressed by references 302(1)-302(4). Each IoT device 302 may be operating with an IoT messaging protocol that is different from the other IoT devices. The IoT devices 302 collectively interface with the IoT platform network 310 which is made up of individual IoT messaging platforms. Each IoT messaging platform supports a particular IoT messaging or connection protocol.

The IoT messaging or connection protocols may include a HTTP connection protocol, a websockets connection protocol, a MQTT connection protocol, a CoAP connection protocol, an AMQP connection protocol, an XMPP connection protocol, a SNMP connection protocol, an AllJoyn connection protocol, or any other appropriate connection protocol.

The MQTT and the AMQP connection protocols currently provide QoS for message deliveries. As discussed in the background section of the disclosure, QoS for these connection protocols is limited to IoT devices operating with the MQTT or the AMQP respective connection protocols.

The system 300 permits QoS to be available on message deliveries between IoT devices 302 operating with the MQTT connection protocol and IoT devices operating with an IoT connection protocol other than MQTT that was not designed to support QoS. Similarly, the system 300 permits QoS to be available on message deliveries between IoT devices 302 operating with the AMQP connection protocol and IoT devices operating with an IoT connection protocol other than AMPQ that was not designed to support QoS. The system 300 also permits QoS to be available on message deliveries between IoT devices 302 operating with connection protocols other than MQTT or AMQP, wherein these connection protocols were not designed to support QoS.

One of ordinary skill in the art will recognize that the IoT platform network 310 may operate using any other appropriate machine-to-machine connection protocol. Other protocols may be added to the IoT platform network 310 over time as the protocols become more universally used.

As discussed above in FIG. 1, the IoT platform network 310 is a cross-protocol, machine-to-machine messaging platform. An example IoT messaging platform is Meshblu by Citrix Octoblu.

Even though four IoT devices 302(1)-302(4) are illustrated, there is no limit on the number of IoT devices that may be operating within the system 300. In addition, any examples given for the different IoT messaging protocols for the illustrated IoT devices 302(1)-302(4) are not to be limiting. Other IoT messaging protocols may be used within the system 300, as readily appreciated by those skilled in the art.

A messaging system server 320 is configured to interface with the different IoT devices 302(1)-302(4). The server 820 includes an interactive API 322 to allow the user to access and communicate with the IoT platform network 310 and to register the IoT devices 302. The messaging system server 320 may be cloud based, for example, and as part of the registration, each IoT device 302 is assigned a UUID, as readily appreciated by those skilled in the art. As part of the registration, anyone of the IoT devices 302 may subscribe to the UUIDs of the other IoT devices.

An IoT device 302 may receive messages from the IoT device it is subscribed too. This means that the IoT device 302 providing the message may be referred to as the sender, and the IoT device 302 receiving the messaging is the subscribing device, which may also be referred to as the receiver. The sender is operating with a first messaging protocol, and the receiver is operating with a second messaging protocol that is different from the first messaging protocol. As part of the message delivery process, the messaging system server 320 translates the message sent from the sender in the first messaging protocol to the second messaging protocol for receipt by the receiver.

A device or controller 304 used to generate commands for controlling the IoT devices 802 is also assigned a UUID. The device 304 may be a fixed device, such as an Arduino Uno micro-controller, for example. Alternatively, the device 304 may be a mobile device with a mobile gateway, such as a mobile phone, tablet, laptop, wearable device, or other suitable mobile device.

The messaging system server 320 includes a Quality of Service (QoS) database 324 providing at least one guaranteed message delivery option 326 for messages being delivered between IoT devices 302. For discussion purposes, a message is to be delivered from a first IoT device 302(1) to a second IoT device 302(2), with each IoT device operating with a different messaging protocol.

The device 304 further cooperates with the messaging system server 302 to associate the at least one guaranteed message delivery option 326 in the QoS database 324 to the message being delivered from the first IoT device 302(1) to the second IoT device 302(2).

The messaging system server 320 includes a QoS message registry 340, with a copy of the message being stored in the QoS message registry during delivery of the message to the second IoT device 302(2). The at least one guaranteed message delivery option 326 includes an option where the message is to be delivered at least once to the second IoT device 302(2) to guarantee delivery. The messaging system server 324 is configured to perform handshaking between the first and second IoT devices 302(1), 302(2) so that the message is delivered at least once to guarantee delivery.

Similarly, the at least one guaranteed message delivery option 326 includes an option where the message is to be delivered only once to the second IoT device 302(2) to guarantee delivery. The messaging system server 324 is configured to perform handshaking between the first and second IoT devices 302(1), 302(2) so that the message is delivered only once to guarantee delivery.

The at least one guaranteed message delivery option 326 may further include an option where the message may be referred to as a best effort delivery (i.e., fire and forget) and provides the same guarantee as the underlying TCP protocol.

The system 300 advantageously allows QoS to be available on message deliveries between IoT devices operating with different messaging protocols. The guaranteed message delivery options are universally applied to the different messaging protocols by the messaging system server 320 even if the messaging protocols were not designed to support QoS. In addition, IoT devices 302 operating with messaging protocols that were designed to support QoS may now have guaranteed message deliveries to IoT devices 302 operating with messaging protocols were not designed to support QoS.

The different messaging protocols each have their pros and cons based on design concerns related to availability of CPU, memory, network bandwidth, power, radios, etc. Since the illustrated system 300 supports guaranteed delivery of messages regardless of messaging protocols, IoT architects and developers now have the option of choosing alternative protocols that were not designed to support QoS, such as the CoAP messaging protocol which is ideal for low bandwidth implementations, and effectively add QoS on top of the CoAP messaging protocol.

The HTTP messaging protocol is another example messaging protocol that is not designed to support QoS. Current systems support HTTP REST APIs for system integration. The illustrated system 300 may advantageously be used to support message delivery for a REST API, HTTP POST command even if the IoT device 302 is offline or under a denial-of-service (DDOS) attack. When the IoT device 302 is back on-line, the system 300 would insure that the IoT device 302 is updated by guaranteeing message delivery.

As another example, the websocket messaging protocol is not designed to support QoS. The websocket messaging protocol may be used to stream information either via client/server or peer-to-peer (P2P) connections. The illustrated system 300 may be used to guarantee delivery of streamlining data and/or audio and video.

As readily appreciated by those skilled in the art, both HTTP and websocket messaging protocols are fundamental web browser supported protocols. Web browsers on the Internet could leverage the illustrated system 300 to guarantee delivery of messages, transactions and/or data.

The QoS database 324 further provides a message delivery acknowledgement option 328 for the message being delivered from the first IoT device 302(1) to the second IoT device 302(1). The device 304 is further configured to associate the message delivery acknowledgment option 328 to the message being delivered to the second IoT device.

The message delivery acknowledgement option 328 includes delivery of an acknowledgment message or a rejection message. The messaging system server 320 is configured to deliver the acknowledgement message to the first IoT device 302(1) when the message has been delivered to the second IoT device 302(2), or deliver the rejection message to the first IoT device 302(1) when the message has been rejected by the second IoT device 302(2). The messaging system server 320 thus operates as a broker between the sender and receiver to guarantee message delivery, and to provide message delivery acknowledgment.

The messaging system server 320 includes a QoS message registry 340, with a copy of the message being stored by the QoS message registry during delivery of the message to the second IoT device 302(2). The QoS database 324 further provides at least one message retention option 330 for the message being delivered from the first IoT device 302(1) to the second IoT device 302(2). The device 304 is further configured to associate the at least one message retention option 330 to the message being delivered to the second IoT device 302(2).

The at least one message retention option 330 includes a delete option. The messaging system server 320 is configured to delete the stored copy of the message in the QoS message registry 340 after delivery of the message to the second IoT device 302(2).

The at least one message retention option 330 includes a storage option. The messaging system server 320 is configured to keep the stored copy of the message in the QoS message registry 340 after delivery to the second IoT device 302(2).

The stored message may include a message body and meta data associated with the message body, with the storage option further including an option for keeping the meta data while deleting the message body.

The messaging system server 320 is further configured to generate a timestamp on when the message was delivered to the second IoT device 302(2), with the storage option further including an option for storing the timestamp.

The messaging system server 320 is further configured to generate at least one restrictions record 332 associated with the plurality of IoT devices 302. The at least one restrictions record 332 allows the messaging system server 320 to control delivery of the message to the second IoT device 302(2) based on at least one of timing restrictions, location restrictions, presence restrictions and path restrictions.

In some embodiments, certain restrictions may be associated with a device, user, or system registered with the messaging system 300 that restrict how or when the device, user, or system can communicate with other devices. Restrictions may include timing restrictions, location restrictions, message envelope restrictions, path restrictions, information throttles, presence restrictions, or any other appropriate restriction. A UUID may designate restrictions for one or more other UUIDs that have access permissions to the UUID. For example, a UUID may store a list of restrictions for any other UUID that has access permissions to the UUID. A UUID's restrictions may be stored in a device directory associated with the UUID.

In some embodiments, the messaging system 300 may enforce the restrictions upon receiving a message by either allowing the message or denying the message. A messaging system gateway may enforce the restrictions. In some embodiments, a device may enforce the restrictions before routing the message to another device or system, or before processing a payload of a message destined for the device.

Timing restrictions may include certain times that a device, user, or system may be accessed. In one example, a first UUID of a first device, user, or system may have timing restrictions associated a second UUID of second device, user, or system. The timing restrictions may indicate certain times for which the second UUID can access the first UUID according to the particular permissions record of the first UUID. For example, the timing restrictions may only allow the second UUID to access the first UUID for a particular week out of the year (e.g., December 23 at midnight through Dec. 28, 2013 at midnight). At times outside of the particular time period, the second UUID may not be allowed to access the first UUID at any permission level, unless otherwise permitted according to the permissions record of the first UUID.

Location restrictions may limit the location or locations at which a device, user, or system may be accessed by other devices, users, or systems. In one example, a first device, user, or system may only be accessed by a second device, user, or system when the first device, user, or system is present at a certain location. In another example, a first device, user, or system may only be accessed by a second device, user, or system when the second device, user, or system is present at a certain location.

The messaging system server 320 is further configured to generate at least one permissions record 334 associated with the plurality of IoT devices 302. The at least one permissions record 334 allows the messaging system server 320 to detect an unauthorized message delivery to the second IoT device 302(2).

In some embodiments, the messaging system 300 may maintain one or more permissions records in respective device directories. Each device or person that is registered with the messaging system 300, and that has been assigned a UUID and token, may have its own permissions record.

A permissions record may include one or more lists, such as a whitelist and/or a blacklist, that are associated with a UUID assigned to a user or person, a device, or a system (or component of a system or device, as described above). In one example, the device directory may maintain a whitelist for a UUID assigned to an IoT device. The whitelist includes a list or array of UUIDs assigned to other devices, users, or systems that are allowed access the IoT device at various levels of access. For example, different levels of access to the IoT device may be granted to other devices, users, or systems, and a separate list or array may be maintained for each level of access.

The whitelist associated with the IoT device's UUID may maintain lists or arrays for the different levels of access, which may include a list or array that includes UUIDs of devices or systems that may discover the device, a list or array of UUIDs of devices or systems that may send a message to the device, a list or array of UUIDs of devices or systems that may receive a message from the device, a list or array of UUIDs of devices or systems that may subscribe to messages sent to and from the device, and/or a list or array of UUIDs of devices or systems that may configure the device.

Accordingly, five levels of access with respect to the IoT device may include the ability to discover the IoT device, the ability to send messages to the IoT device, the ability to receive messages from the IoT device, the ability to subscribe to messages that are received and transmitted by the IoT device, and the ability to configure the IoT device. One of ordinary skill will appreciate that the five levels of access are only examples, and that other levels of access may also be granted.

Additional implementation of the restrictions record 332 and the permissions record 334 may be found in U.S. Pat. No. 9,094,407. The '407 patent is assigned to the current assignee of the present application, and is incorporated herein by reference in its entirety.

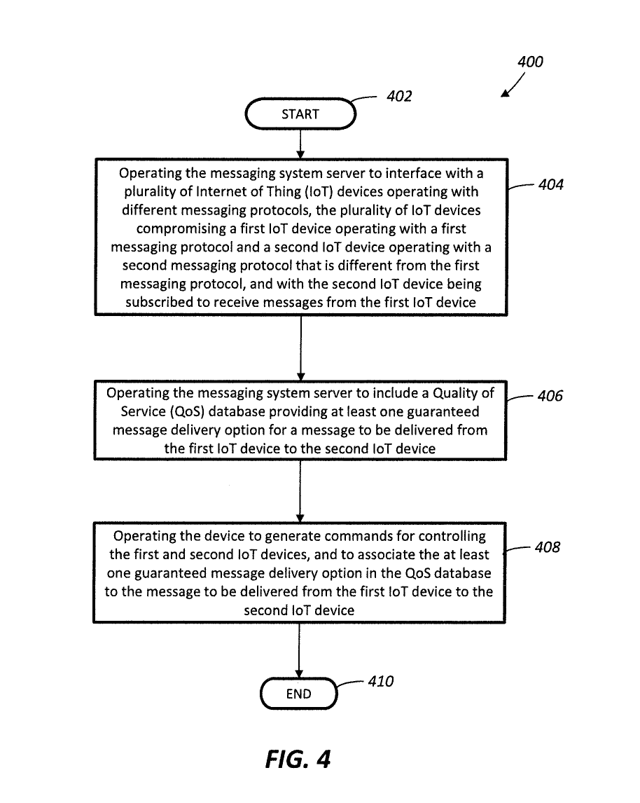

Another aspect is directed to a method for operating the system 300 as described above based on providing guaranteed message delivery options for IoT devices 302. Referring to the flowchart 400 in FIG. 4, the method comprises from the start (Block 402), operating the messaging system server 320 at Block 404 to interface with a plurality of Internet of Thing (IoT) devices 302 operating with different messaging protocols. The plurality of IoT devices 302 include a first IoT device 302(1) operating with a first messaging protocol and a second IoT device 302(2) operating with a second messaging protocol that is different from the first messaging protocol. The second IoT device 302(2) is subscribed to receive messages from the first IoT device 302(1). The messaging system server 320 is operated at Block 406 to include a Quality of Service (QoS) database 324 providing at least one guaranteed message delivery option 326 for a message being delivered from the first IoT device 302(1) to the second IoT device 302(2). The device 304 is operated at Block 408 to generate commands for controlling the first and second IoT devices, and to associate the at least one guaranteed message delivery option 326 in the QoS database 324 to the message being delivered from the first IoT device 302(1) to the second IoT device 302(2). The method ends at Block 410.

The flowchart 400 is illustrated as a logical flow diagram, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Yet another aspect of the disclosure is directed to a non-transitory computer readable medium having a plurality of computer executable instructions for causing the system 300 as described above to operate. More particularly, the messaging system server 320 is operated to interface with a plurality of Internet of Thing (IoT) devices 302 operating with different messaging protocols. The plurality of IoT devices 302 include a first IoT device 302(1) operating with a first messaging protocol and a second IoT device 302(2) operating with a second messaging protocol that is different from the first messaging protocol. The second IoT device 302(2) is subscribed to receive messages from the first IoT device 302(1). The messaging system server 320 is operated to include a Quality of Service (QoS) database 324 providing at least one guaranteed message delivery option 326 for a message being delivered from the first IoT device 302(1) to the second IoT device 302(2). The device 304 is operated to generate commands for controlling the first and second IoT devices, and to associate the at least one guaranteed message delivery option 326 in the QoS database 324 to the message being delivered from the first IoT device 302(1) to the second IoT device 302(2).

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the foregoing description.

That which is claimed:

1. A system comprising:
a messaging system server configured to interface with a plurality of Internet of Thing (IoT) devices operating with different messaging protocols, the plurality of IoT devices comprising a first IoT device operating with a first messaging protocol and a second IoT device operating with a second messaging protocol that is different from the first messaging protocol, and with the second IoT device being subscribed to receive messages from the first IoT device;
said messaging system server comprising a Quality of Service (QoS) database providing at least one guaranteed message delivery option for a message being delivered from the first IoT device to the second IoT device; and
a device cooperating with said messaging system server and configured to generate commands for controlling the first and second IoT devices, and to associate the at least one guaranteed message delivery option in the QoS database to the message being delivered from the first IoT device to the second IoT device.

2. The system according to claim 1 wherein said messaging system server comprises a QoS message registry, with a copy of the message being stored in the QoS message registry during delivery of the message to the second IoT device.

3. The system according to claim 2 wherein the at least one guaranteed message delivery option includes an option where the message is to be delivered at least once to the second IoT device to guarantee delivery; and wherein said messaging system server is configured to perform handshaking between the first and second IoT devices so that the message is delivered at least once to guarantee delivery.

4. The system according to claim 2 wherein the at least one guaranteed message delivery option includes an option where the message is to be delivered only once to the second IoT device to guarantee delivery; and wherein said messaging system server is configured to perform handshaking between the first and second IoT devices so that the message is delivered only once to guarantee delivery.

5. The system according to claim 1 wherein the QoS database further provides a message delivery acknowledgement option for the message being delivered from the first IoT device to the second IoT device; and wherein said device is further configured to associate the message delivery acknowledgment option to the message being delivered to the second IoT device.

6. The system according to claim 5 wherein the message delivery acknowledgement option includes delivery of an acknowledgment message or a rejection message; and wherein said messaging system server is configured to deliver the acknowledgement message to the first IoT device when the message has been delivered to the second IoT device, or deliver the rejection message to the first IoT device when the message has been rejected by the second IoT device.

7. The system according to claim 1 wherein said messaging system server comprises a QoS message registry, with a copy of the message being stored by the QoS message registry during delivery of the message to the second IoT device; wherein the QoS database further provides at least one message retention option for the message being delivered from the first IoT device to the second IoT device; and wherein said device is further configured to associate the at least one message retention option to the message being delivered to the second IoT device.

8. The system according to claim 7 wherein the at least one message retention option includes a delete option; and wherein said messaging system server is configured to delete the stored copy of the message in the QoS message registry after delivery of the message to the second IoT device.

9. The system according to claim 7 wherein the at least one message retention option includes a storage option; and wherein said messaging system server is configured to keep the stored copy of the message in the QoS message registry after delivery to the second IoT device.

10. The system according to claim 9 wherein the stored message includes a message body and meta data associated with the message body, with the storage option further including an option for keeping the meta data while deleting the message body.

11. The system according to claim 9 wherein said messaging system server is further configured to generate a timestamp on when the message was delivered to the second IoT device, with the storage option further including an option for storing the timestamp.

12. The system according to claim 1 wherein said messaging system server is further configured to generate at least one restrictions record associated with the plurality of IoT devices, with the at least one restrictions record allowing said messaging system server to control delivery of the message to the second IoT device based on at least one of timing restrictions, location restrictions, presence restrictions and path restrictions.

13. The system according to claim 1 wherein said messaging system server is further configured to generate at least one permissions record associated with the plurality of IoT devices, with the at least one permissions record allowing said messaging system server to detect an unauthorized message delivery to the second IoT device.

14. A method for operating a system comprising a messaging system server and a device cooperating with the messaging system server, the method comprising:
operating the messaging system server to interface with a plurality of Internet of Thing (IoT) devices operating with different messaging protocols, the plurality of IoT devices comprising a first IoT device operating with a first messaging protocol and a second IoT device operating with a second messaging protocol that is different from the first messaging protocol, and with the second IoT device being subscribed to receive messages from the first IoT device;
operating the messaging system server to include a Quality of Service (QoS) database providing at least one guaranteed message delivery option for a message being delivered from the first IoT device to the second IoT device; and
operating the device to generate commands for controlling the first and second IoT devices, and to associate the at least one guaranteed message delivery option in the QoS database to the message being delivered from the first IoT device to the second IoT device.

15. The method according to claim 14 wherein the messaging system server comprises a QoS message registry; further comprising storing a copy of the message in the QoS message registry during delivery of the message to the second IoT device.

16. The method according to claim 15 wherein the at least one guaranteed message delivery option includes an option where the message is to be delivered at least once to the second IoT device to guarantee delivery; and further comprising operating the messaging system server to perform handshaking between the first and second IoT devices so that the message is delivered at least once to guarantee delivery.

17. The method according to claim 15 wherein the at least one guaranteed message delivery option includes an option where the message is to be delivered only once to the second IoT device to guarantee delivery; and further comprising operating the messaging system server to perform handshaking between the first and second IoT devices so that the message is delivered only once to guarantee delivery.

18. The method according to claim 14 wherein the QoS database further provides a message delivery acknowledgement option for the message being delivered from the first IoT device to the second IoT device; and further comprising operating the device to associate the message delivery acknowledgment option to the message being delivered to the second IoT device.

19. The method according to claim 18 wherein the message delivery acknowledgement option includes delivery of an acknowledgment message or a rejection message; and further comprising operating the messaging system server to deliver the acknowledgement message to the first IoT device when the message has been delivered to the second IoT device, or deliver the rejection message to the first IoT device when the message has been rejected by the second IoT device.

20. The method according to claim 14 wherein the messaging system server comprises a QoS message registry, with a copy of the message being stored by the QoS message registry during delivery of the message to the second IoT device; wherein the QoS database further provides at least one message retention option for the message being delivered from the first IoT device to the second IoT device; and further comprising operating the device to associate the at least one message retention option to the message being delivered to the second IoT device.

21. A non-transitory computer readable medium having a plurality of computer executable instructions for causing a system comprising a messaging system server and a device cooperating with the messaging system server to perform steps comprising:
operating the messaging system server to interface with a plurality of Internet of Thing (IoT) devices operating with different messaging protocols, the plurality of IoT devices comprising a first IoT device operating with a first messaging protocol and a second IoT device operating with a second messaging protocol that is different from the first messaging protocol, and with the second IoT device being subscribed to receive messages from the first IoT device;
operating the messaging system server to include a Quality of Service (QoS) database providing at least one guaranteed message delivery option for a message being delivered from the first IoT device to the second IoT device; and
operating the device to generate commands for controlling the first and second IoT devices, and to associate the at least one guaranteed message delivery option in the QoS database to the message being delivered from the first IoT device to the second IoT device.

22. The non-transitory computer readable medium according to claim 21 wherein the messaging system server comprises a QoS message registry, and further comprising the step of storing a copy of the message in the QoS message registry during delivery of the message to the second IoT device.

23. The non-transitory computer readable medium according to claim 22 wherein the at least one guaranteed message delivery option includes an option where the message is to be delivered at least once to the second IoT device to guarantee delivery; and further comprising the step of operating the messaging system server to perform handshaking between the first and second IoT devices so that the message is delivered at least once to guarantee delivery.

24. The non-transitory computer readable medium according to claim 22 wherein the at least one guaranteed message delivery option includes an option where the message is to be delivered only once to the second IoT device to guarantee delivery; and further comprising the step of operating the messaging system server to perform handshaking between the first and second IoT devices so that the message is delivered only once to guarantee delivery.

25. The non-transitory computer readable medium according to claim 21 wherein the QoS database further provides a message delivery acknowledgement option for the message being delivered from the first IoT device to the second IoT device; and further comprising operating the device to associate the message delivery acknowledgment option to the message being delivered to the second IoT device.
